(19) United States
(12) Patent Application Publication
(10) Pub. No.: US 2007/0105515 A1
(43) Pub. Date: May 10, 2007

(54) Apparatus and method for providing automatic gain control

(76) Inventors: Max Ward Muterspaugh, Indianapolis, IN (US); Matthew Thomas Mayer, Avon, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/579,101

(22) PCT Filed: Dec. 14, 2004
(86) PCT No.: PCT/US04/41855

§ 371 Date: May 10, 2006

Related U.S. Application Data
(60) Provisional application No. 60/531,727, filed on Dec. 22, 2003.

(51) Int. Cl. H04B 7/00

(52) U.S. Cl. 455/234.1

(57) ABSTRACT

Signal processing apparatus (100) such as a television signal receiver provides automatic gain control (AGC) in a manner that avoids excessive tuner gain reduction and compensates for interference from both analog and digital signals. According to an exemplary embodiment, the signal processing apparatus (100) includes a tuner (10) operative to tune an RF signal to generate an IF signal. A first filter (20) is operative to filter the IF signal to generate a filtered IF signal. An AGC detector (30) is operative to enable generation of an AGC signal for the tuner (10) responsive to the filtered IF signal. The AGC detector (30) includes a second filter (35) operative to attenuate a predetermined carrier frequency.

### BACKGROUND OF THE INVENTION

1. Field of the Invention

The present invention generally relates to automatic gain control (AGC) for apparatuses such as television signal receivers, and more particularly, to an apparatus and method for providing AGC that avoids excessive tuner gain reduction and compensates for interference from both analog and digital signals.

2. Background Information

Apparatuses such as television signal receivers use AGC to control the gain of a tuner in order to maintain the amplitude of the tuner's output signal at a relatively constant level. One problem associated with current AGC techniques may occur when a relatively weak desired signal is being received in the presence of much stronger undesired adjacent signals that overload the tuner and interfere with the reception of the desired signal.

The aforementioned problem is particularly applicable to television signal receivers capable of receiving both analog and digital signals. Prior to the introduction of digital television, adjacent channel frequencies were never assigned in the same geographical area. This practice, in the vast majority of cases, prevented interference from adjacent channel frequencies. With the introduction of digital television, however, it was required that adjacent channels be used such that both analog and digital signals could be transmitted during a transition period until virtually all television signal receivers are replaced with new units capable of digital reception. As a result, a relatively weak desired analog or digital television signal may suffer interference from stronger undesired adjacent analog or digital signals.

Known AGC techniques detect the presence of stronger undesired adjacent signals and compensate for them by reducing the gain of the tuner. In certain cases, however, the tuner gain may be reduced to a very low level such that the desired signal is below a critical level for proper demodulation. For example, in cases where the undesired adjacent signals are 20 to 40 dB stronger than the desired signal, known AGC techniques often reduce the tuner gain to a level that prevents proper demodulation. Known AGC techniques are also deficient in that they fail to make adequate provision for interference from both digital and analog signals.

Accordingly, there is a need for an apparatus and method for providing AGC that addresses the foregoing problems, and thereby avoids excessive tuner gain reduction and compensates for interference from both analog and digital signals. The present invention addresses these and/or other issues.

### SUMMARY OF THE INVENTION

In accordance with an aspect of the present invention, signal processing apparatus is disclosed. According to an exemplary embodiment, the signal processing apparatus comprises tuning means for tuning an RF signal to generate an IF signal. First filtering means filter the IF signal to generate a filtered IF signal. AGC detecting means enables generation of an AGC signal for the tuning means responsive to the filtered IF signal. The AGC detecting means includes second filtering means for attenuating a predetermined carrier frequency.

In accordance with another aspect of the present invention, a method for providing AGC is disclosed. According to an exemplary embodiment, the method comprises steps of using a tuner to tune an RF signal to generate an IF signal, filtering the IF signal to generate a filtered IF signal, generating an AGC signal responsive to the filtered IF signal, wherein the generating step includes attenuating a predetermined carrier frequency, and providing the AGC signal to the tuner.

In accordance with still another aspect of the present invention, a television signal receiver is disclosed. According to an exemplary embodiment, the television signal receiver comprises a tuner operative to tune an RF signal to generate an IF signal. A first filter is operative to filter the IF signal to generate a filtered IF signal. An AGC detector is operative to enable generation of an AGC signal for the tuner responsive to the filtered IF signal. The AGC detector includes a second filter operative to attenuate a predetermined carrier frequency.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of signal processing apparatus according to an exemplary embodiment of the present invention;

FIG. 2 is a schematic circuit diagram of the AGC detector of FIG. 1 according to an exemplary embodiment of the present invention;

FIG. 3 is a frequency response graph illustrating relationships between output voltage and input frequency according to an exemplary embodiment of the present invention; and

FIG. 4 is a flowchart illustrating steps according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

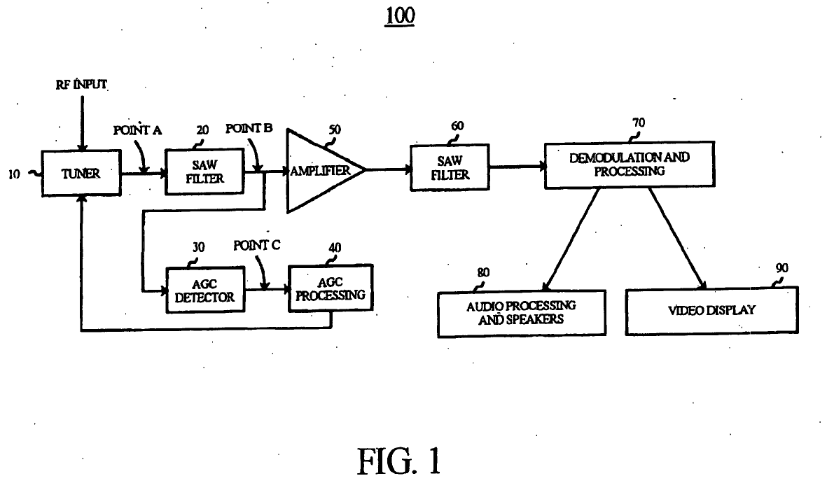

Referring now to the drawings, and more particularly to FIG. 1, signal processing apparatus 100 according to an exemplary embodiment of the present invention is shown. Signal processing apparatus 100 may for example represent the front-end processing circuitry of a receiving device such as television signal receiver and/or other device.

As shown in FIG. 1, signal processing apparatus 100 comprises tuning means such as tuner 10, first filtering means such as surface acoustic wave (SAW) filter 20, AGC detecting means such as AGC detector 30, AGC processing means such as AGC processing block 40, amplifying means such as amplifier 50, another filtering means such as SAW filter 60, demodulation and processing means such as demodulation and processing block 70, audio processing and output means such as audio processing and speakers block 80, and display means such as video display 90. Some of the aforementioned elements of FIG. 1 may be embodied using integrated circuits (ICs), and some elements may for example be included on one or more ICs. For clarity of description, certain elements associated with signal processing apparatus 100 such as certain control signals (e.g., channel selection signals), power signals and/or other elements may not be shown in FIG. 1.

Tuner 10 is operative to perform a signal tuning function. According to an exemplary embodiment, tuner 10 receives an RF input signal from a signal source such as a terrestrial, cable, satellite, internet and/or other signal source, and performs the signal tuning function by filtering and frequency downconverting (i.e., single or multiple stage downconversion) the RF input signal to thereby generate an IF signal between 41 and 47 MHz. This IF signal is represented at Point A in FIG. 1. The RF input signal and IF signal may include audio, video and/or data content, and may be of an analog modulation scheme (e.g., NTSC, PAL, SECAM, etc.) and/or a digital modulation scheme (e.g., ATSC, QAM, etc.). Also according to an exemplary embodiment, tuner 10 receives an RF AGC signal from AGC processing circuitry 40 which enables an AGC function.

SAW filter 20 is operative to filter the IF signal provided from tuner 10 to thereby generate differential, filtered IF signals. These filtered IF signals are represented at Point B in FIG. 1. According to an exemplary embodiment, SAW filter 20 includes one or more individual SAW filters which remove a substantial portion of the undesired, adjacent channel energy from the IF signal provided from tuner 10 to generate the differential, filtered IF signals. Differential, or balanced, operation with respect to a circuit ground minimizes interference from stray coupling, including capacitive coupling from the input of SAW filter 20 that can degrade out of band rejection of SAW filter 20. According to this exemplary embodiment, the frequency response of SAW filter 20 slightly exceeds the frequency range from 41 to 47 MHz. In this manner, digital adjacent channel interference can be well controlled given that digital television signals are characterized by having a very uniform distribution of power over their bandwidth. As indicated in FIG. 1, one of the differential, filtered IF signals output from SAW filter 20 is provided to AGC detector 40 to enable the AGC function of tuner 10.

AGC detector 30 is operative to sample a predetermined signal and enable generation of an RF AGC signal for tuner 10. According to the exemplary embodiment of FIG. 1, AGC detector 30 samples one of the differential, filtered IF signals output from SAW filter 20 and generates an output signal which enables generation of the RF AGC signal. Since only a portion of the undesired, adjacent channel energy is present in the differential, filtered IF signal provided from SAW filter 20, the RF AGC signal may be generated having an optimum balance of digital adjacent channel interference and the desired signal. As will be described later herein, AGC detector 30 also includes filtering means for attenuating a predetermined carrier frequency, namely an analog sound carrier, to thereby minimize any analog adjacent channel interference. AGC detector 30 may be used in multiple tuner environments. As such, AGC detector 30 may receive control signals (not shown) that vary its operating characteristics as a function of the selected tuner. Further details regarding AGC detector 30 will be provided later herein.

AGC processing block 40 is operative to perform processing functions associated with generating the RF AGC signal for tuner 10. According to an exemplary embodiment, AGC processing block 40 performs functions including, but not limited to, monitoring thresholds above which gain reduction begins, and adjusting AGC speed. AGC processing block 40 may for example be implemented using an IC such as a NXT2004 manufactured by ATI. However, with respect to the inventive concepts of the present invention, AGC processing block 40 is not required. Accordingly, the output signal of AGC detector 30 could be directly applied to tuner 10 as the RF AGC signal.

Amplifier 50 is operative to amplify the filtered IF signals provided from SAW filter 20 to thereby generate an amplified IF signal. SAW filter 60 is operative to filter the amplified IF signal provided from amplifier 50 to thereby generate another set of differential, filtered IF signals for demodulation and further processing.

Demodulation and processing block 70 is operative to demodulate and further process (e.g., decode, etc.) the differential, filtered IF signals provided from SAW filter 60 to thereby generate demodulated audio and/or video signals for output. According to an exemplary embodiment, demodulation and processing block 70 is operative to perform various different types of signal demodulation including analog demodulation (e.g., NTSC, PAL, SECAM, etc.) and digital demodulation (e.g., ATSC, QAM, etc.), as well as various types of signal decoding including analog decoding (e.g., NTSC, PAL, SECAM, etc.) and digital decoding (e.g., MPEG, etc.).

Audio processing and speakers block 80 is operative to process the demodulated audio signals provided from demodulation and processing block 70 and provide an audio output. Video display 90 is operative to provide a video display corresponding to the demodulated video signals provided from demodulation and processing block 70.

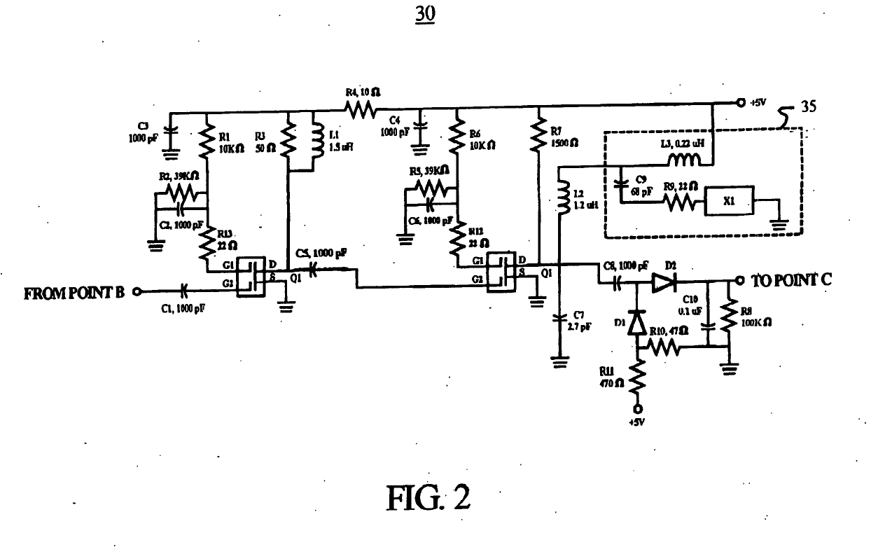

Referring to FIG. 2, a schematic circuit diagram of AGC detector 30 of FIG. 1 according to an exemplary embodiment of the present invention is shown. As shown in FIG. 2, AGC detector 30 comprises resistors R1 to R13, capacitors C1 to C10, inductors L1 to L3, transistors Q1 and Q2, diodes D1 and D2, and a ceramic resonator X1. Exemplary values for resistors R1 to R13, capacitors C1 to C10, and inductors L1 to L3 are shown in FIG. 2. Other values could also be used. Transistors Q1 and Q2 of FIG. 2 are each embodied as a dual gate metal oxide semiconductor field effect transistor (MOSFET), such as a model BF1005 transistor manufactured by Infineon. Diodes D1 and D2 of FIG. 2 are each embodied as a Schottky diode, such as a model 1PS76SB17 diode manufactured by Phillips. Ceramic resonator X1 of FIG. 2 may for example be embodied as a model MKTGA47M2CAHP00B05 ceramic filter manufactured by Murata.

As shown in FIG. 2, resistor R9, capacitor C9, inductor L3, and ceramic resonator X1 represent a “trap” filter 35. According to an exemplary embodiment, trap filter 35 is operative to attenuate a predetermined carrier frequency, namely a 47.25 MHz analog sound carrier. In analog television, such as NTSC, signal power is concentrated near the carriers, specifically the picture and sound carriers. In the presence of analog channel interference, the adjacent sound carrier of 47.25 MHz is very close to the band edge of the desired signal. The presence of this sound carrier can produce too much power and thereby cause the gain of tuner 10 to be adversely reduced more than desired. With trap filter 35 of FIG. 2, this problem is addressed in that ceramic resonator X1 is tuned to shunt 47.25 MHz frequencies. Inductor L3 and capacitor C9 are provided to optimize impedances and resistor R9 is provided to control the amount of attenuation of the 47.25 MHz sound carrier.

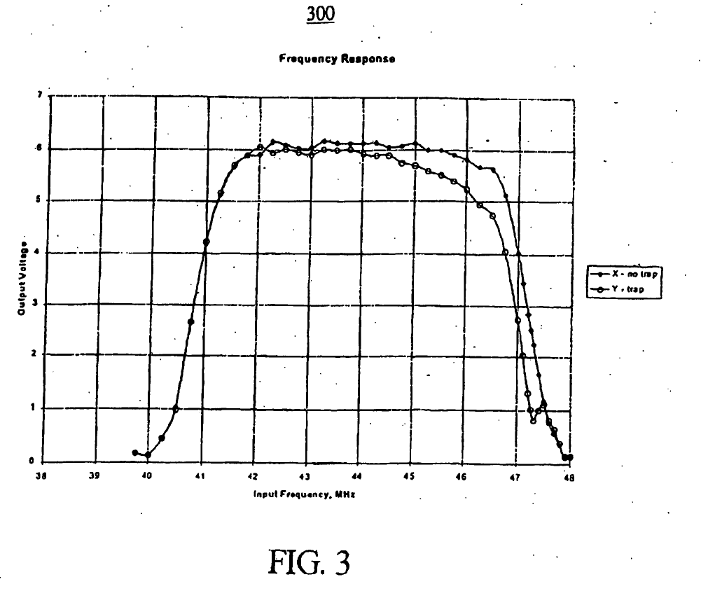

By controlling the frequency response of SAW filter 20 and providing trap filter 35 as described above, the resulting RF AGC signal applied to tuner 10 is not only optimized to prevent overload of a much greater variation of interfering signal levels, but is also optimized for both analog and digital interfering signals. The benefits of the present invention are evident from the frequency response graph of FIG. 3 described below.

Referring to FIG. 3, a frequency response graph 300 illustrating relationships between output voltage and input frequency according to an exemplary embodiment of the present invention is shown. In particular, FIG. 3 shows a plot of output voltage versus input frequency for a signal applied to SAW filter 20 at Point A of FIG. 1 and an output voltage measured at Point C of FIG. 1. Two frequency responses are shown in graph 300 of FIG. 3. Curve X is taken without the addition of trap filter 35 of FIG. 2. Curve Y is taken with the addition of trap filter 35 and shows the adjustment in frequency response made to optimize operation for analog interfering signals. In graph 300 of FIG. 3, the frequency response between 47 and 48 MHz is the adjacent channel bandwidth that is processed to effect the gain control of tuner 10 in the presence of adjacent analog channel interference.

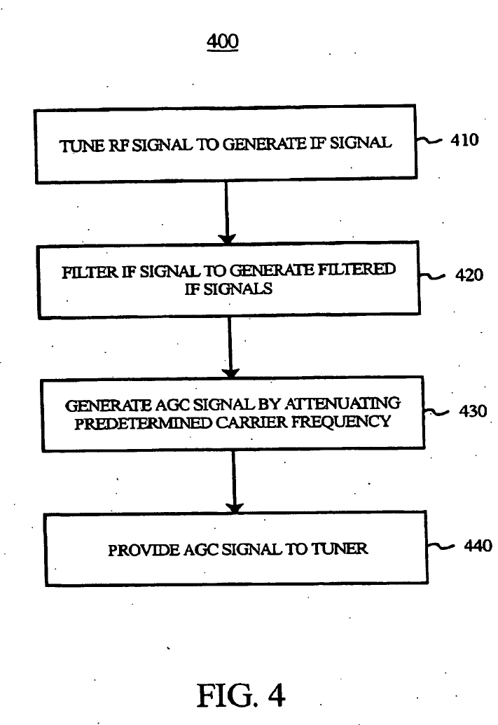

Referring to FIG. 4, a flowchart 400 illustrating steps according to an exemplary embodiment of the present invention is shown. For purposes of example and explanation, the steps of FIG. 4 will be described with reference to elements of signal processing apparatus 100 of FIG. 1. The steps of FIG. 4 are merely exemplary, and are not intended to limit the present invention in any manner.

At step 410, signal processing apparatus 100 tunes an RF signal to generate a corresponding IF signal. According to an exemplary embodiment, tuner 10 receives an RF input signal from a signal source such as a terrestrial, cable, satellite, internet and/or other signal source, and performs the signal tuning function by filtering and frequency downconverting (i.e., single or multiple stage downconversion) the RF input signal to thereby generate an IF signal between 41 and 47 MHz, at step 410. This IF signal is represented at Point A in FIG. 1. As previously indited herein, the RF input signal and IF signal may include audio, video and/or data content, and may be of an analog modulation scheme (e.g., NTSC, PAL, SECAM, etc.) and/or a digital modulation scheme (e.g., ATSC, QAM, etc.).

At step 420, signal processing apparatus 100 filters the IF signal to generate filtered IF signals. According to an exemplary embodiment, SAW filter 20 filters the IF signal generated by tuner 10 at step 410 to thereby generate differential, filtered IF signals at step 420. These filtered IF signals are represented at Point B in FIG. 1. As previously indicated herein, the frequency response of SAW filter 20 slightly exceeds the frequency range from 41 to 47 MHz and thereby contains some digital adjacent channel interference.

At step 430, signal processing apparatus 100 generates an AGC signal responsive to one of the filtered IF signals by attenuating a predetermined carrier frequency. According to an exemplary embodiment, AGC detector 30 samples one of the differential, filtered IF signals generated by SAW filter 20 at step 420 and generates an output signal which enables generation of the RF AGC signal at step 430. As previously indicated herein, AGC detector 30 includes trap filter 35 which attenuates the 47.25 MHz analog sound carrier and thereby controls analog adjacent channel interference. The AGC signal generated at step 430 may be the direct output of AGC detector 30, or may be the output of AGC processing block 40 as previously described herein.

At step 440, signal processing apparatus 100 provides the AGC signal to its tuner 10. According to an exemplary embodiment, the AGC signal generated at step 430 is provided to tuner 10 from either AGC detector 30 or AGC processing block 40 depending on the particular embodiment. The AGC signal in turn controls the gain of tuner 10 and thereby facilitates the RF AGC function of signal processing apparatus 100.

As described herein, the present invention provides an apparatus and method for providing AGC that avoids excessive tuner gain reduction and compensates for interference from both analog and digital signals. The present invention may be applicable to various apparatuses, either with or without a display device. Accordingly, the phrases “signal processing apparatus” and “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), radios, computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. Signal processing apparatus, comprising:
tuning means for tuning an RF signal to generate an IF signal;
first filtering means for filtering said IF signal to generate a filtered IF signal;
AGC detecting means for enabling generation of an AGC signal for said tuning means responsive to said filtered IF signal; and
wherein said AGC detecting means includes second filtering means for attenuating a predetermined carrier frequency.

2. The signal processing apparatus of claim 1, wherein said IF signal is between 41 and 47 MHz.

3. The signal processing apparatus of claim 1, wherein said first filtering means includes a SAW filter.

4. The signal processing apparatus of claim 1, wherein said predetermined carrier frequency corresponds to an analog sound carrier frequency.

5. The signal processing apparatus of claim 1, wherein said predetermined carrier frequency corresponds to approximately 47.25 MHz.

6. The signal processing apparatus of claim 1, wherein said second filtering means includes a ceramic resonator tuned to shunt said predetermined carrier frequency.

7. A method for providing AGC, comprising steps of:
using a tuner to tune an RF signal to generate an IF signal;
filtering said IF signal to generate a filtered IF signal;
generating an AGC signal responsive to said filtered IF signal, wherein said generating step includes attenuating a predetermined carrier frequency; and
providing said AGC signal to said tuner.

8. The method of claim 7, wherein said IF signal is between 41 and 47 MHz.

9. The method of claim 7, wherein said filtering step includes using a SAW filter.

10. The method of claim 7, wherein said predetermined carrier frequency corresponds to an analog sound carrier frequency.

11. The method of claim 7, wherein said predetermined carrier frequency corresponds to approximately 47.25 MHz.

12. The method of claim 7, wherein said generating step further includes using a ceramic resonator to shunt said predetermined carrier frequency.

13. A television signal receiver, comprising:
a tuner operative to tune an RF signal to generate an IF signal;
a first filter operative to filter said IF signal to generate a filtered IF signal;
an AGC detector operative to enable generation of an AGC signal for said tuner (10) responsive to said filtered IF signal; and
wherein said AGC detector includes a second filter operative to attenuate a predetermined carrier frequency.

14. The television signal receiver of claim 13, wherein said IF signal is between 41 and 47 MHz.

15. The television signal receiver of claim 13, wherein said first filter includes a SAW filter.

16. The television signal receiver of claim 13, wherein said predetermined carrier frequency corresponds to an analog sound carrier frequency.

17. The television signal receiver of claim 13, wherein said predetermined carrier frequency corresponds to approximately 47.25 MHz.

18. The television signal receiver of claim 13, wherein said second filter includes a ceramic resonator tuned to shunt said predetermined carrier frequency.
